(19) United States
(12) Patent Application Publication
(10) Pub. No.: US 2025/0102066 A1
(43) Pub. Date: Mar. 27, 2025

(54) JOINT AND INDUSTRIAL DEVICE

(71) Applicant: ABB Schweiz AG, Baden (CH)

(72) Inventors: Jiangwei Huang, Västerås (SE); Shanghua Li, Västerås (SE); Tomas Botold, Västerås (SE); Arne Trangärd, Västerås (SE)

(21) Appl. No.: 18/832,198

(22) PCT Filed: Feb. 2, 2022
(86) PCT No.: PCT/EP2022/052470

§ 371 Date: Jul. 23, 2024

(51) Int. Cl. F16J 15/3284; B25J 19/00

(52) U.S. Cl. CPC F16J 15/3284; B25J 19/0075

(57) ABSTRACT

A joint including a first part and a second part rotatable relative to each other about a rotation axis, the second part having a second surface; a dynamic seal arranged to dynamically seal against the second surface; and a static seal arranged to seal a gap between the first part and the dynamic seal, and arranged to push the dynamic seal against the second surface; wherein the static seal in the gap is exposed to an external region outside the joint. An industrial device including a joint is also provided.

### TECHNICAL FIELD

The present disclosure generally relates to a joint. In particular, a joint comprising a dynamic seal and a static seal, and an industrial device comprising such joint, are provided.

### BACKGROUND

In some processing environments, it is desirable to maintain a high level of hygiene. Examples of such processing environments include environments where food, beverages or pharmaceuticals are handled by an industrial robot. Any sanitary problem in such processing environment might result in severe consequences. For this reason, comprehensive cleaning of the robot and its surroundings is often performed on a daily basis. Typical cleaning procedures include high pressure washing with hot water containing chemical agents, such as strong acidic or alkaline detergents and disinfectants.

An industrial robot typically comprises seals between its moving parts to prevent media from an external region with respect to the robot to enter an internal region of the robot, and vice versa. When water reaches the internal region, corrosion is accelerated and contaminants can be carried by the water to the internal region. Leakage of gearboxes is also a common issue occurring in industrial robots. When the sealing solution is insufficient, a food grade lubricant might be contaminated in the internal region and pass through the seal to the external region.

US 2020101628 A1 discloses a sealing apparatus for a robot. The sealing apparatus comprises a first enclosure, a second enclosure, a seal and an elastomer. The first enclosure may rotate relative to the second enclosure. The seal and the second enclosure cooperatively define a chamber. The elastomer is positioned in the chamber and is compressed between the seal and the second enclosure. The seal abuts both the first and second enclosures.

In the sealing apparatus in US 2020101628 A1, the seal is tightly fitted between the first and second enclosures. There are therefore two interfaces providing pockets where bacteria will enter. The design of the sealing apparatus is therefore not satisfactory from a hygienic perspective. Moreover, the tight fit of the seal to each of the first and second enclosures requires narrow tolerances and surface treatments in each of these two interfaces, which adds costs.

### SUMMARY

One object of the invention is to provide an improved joint.

A further object of the invention is to provide an improved industrial device.

These objects are achieved by the joint according to claim 1 and the industrial device according to claim 15.

The invention is based on the realization that by providing a joint having a first part, a second part and a static seal arranged to push a dynamic seal against a second surface of the second part, where the static seal seals a gap between the first part and the dynamic seal, and where the static seal is exposed to an external region outside the joint, the hygienic design can be improved and the requirements of surface treatments of the first part adjacent to the static seal can be relaxed.

According to a first aspect, there is provided a joint comprising a first part and a second part rotatable relative to each other about a rotation axis, the second part having a second surface; a dynamic seal arranged to dynamically seal against the second surface; and a static seal arranged to seal a gap between the first part and the dynamic seal, and arranged to push the dynamic seal against the second surface; wherein the static seal in the gap is exposed to an external region outside the joint.

The dynamic seal and the static seal form a liquid and dust proof sealing solution between the relatively rotatable first part and second part. The joint is excellent in applications in food and beverage industries and in pharmaceutical industries.

Since the static seal is exposed to the external region in the gap, there is no bacterial pocket radially outside the static seal in the gap. Furthermore, in case the dynamic seal and the first part are made of relatively hard materials, there would be an increased risk of bacterial growth if these were in direct contact with each other. Due to the dynamic seal being separated from the first part by the gap, any contact between the dynamic seal and the first part at an external side can be avoided. The hygienic design of the joint is thereby greatly improved. Moreover, this separation by the gap enables surface treatment of the first part to be eliminated, or to be made less complicated, and tolerances to be relaxed, without deteriorating the hygienic design.

The static seal may be elastic. In this way, the static seal can be axially compressed (with respect to the rotation axis) in use of the joint. The axial compression of the static seal causes the static seal to radially expand and increase the sealing against the first part.

The joint comprises only one dynamic sealing interface, namely between the dynamic seal and the second surface. The interface between the static seal and the dynamic seal is a static sealing interface if the static seal and the dynamic seal are separate components.

Each of the first part and the second part may be made of metal, such as stainless steel. In this case, since there is only one dynamic sealing interface towards metal (between the dynamic seal and the second surface), the second surface may be surface treated but surface treatment of the first part in contact with the static seal can be avoided.

The gap may be an axial gap with respect to the rotation axis. The gap may be annular and concentric with the rotation axis. Alternatively, or in addition, the second surface may be annular and concentric with the rotation axis.

The dynamic seal may be a face seal. The dynamic seal may comprise, or may be constituted by, a plastic material and/or a polymer material, such as polytetrafluoroethylene (PTFE). The material of the dynamic seal may be a food grade material, for example according to the directives of the U.S. Food and Drug Administration (FDA). The dynamic seal may be annular and concentric with the rotation axis.

The static seal may be arranged to push the dynamic seal substantially in an axial direction, or in an axial direction, parallel with the rotation axis. The static seal may be a face seal. The static seal may comprise, or may be constituted by, a rubber material and/or an elastomer. According to one example, the static seal is made of a hybrid material comprising elastomer and plastic. The material of the static seal may be a food grade material, for example according to the directives of the U.S. Food and Drug Administration (FDA). The static seal may be annular and concentric with the rotation axis.

The static seal and the dynamic seal may be separate components that are held together. Alternatively, the static seal may be connected to the dynamic seal, for example by bonding.

The second surface may be a substantially axial surface with respect to the rotation axis, such as an axial surface, i.e. a surface perpendicular to the rotation axis. A substantially axial surface may be inclined 70° to 110° to the rotation axis. The second surface may thus be flat or conical.

The static seal may be made of a material that is softer than a material of the dynamic seal. The static seal may be made of a material having a Shore A hardness of less than 80, such as less than 70, such as less than 60. Alternatively, or in addition, the dynamic seal may be made of a material having a Shore D hardness of at least 30, such as at least 40, such as at least 50. The Shore A hardness and the Shore D hardness may be measured according to DIN 53505 or ISO 868:2003.

The first part may partly overlap the static seal. The partial overlapping of the static seal by the first part in combination with the static seal sealing the gap between the first part and the dynamic seal provides an improved hygienic design of the joint. The joint thus provides a high performance sealing solution with a design of low complexity.

Since the first part partly overlaps the static seal, the first part is at least partly provided radially outside the static seal with respect to the rotation axis. A radially outwardly facing surface of the static seal may be in contact with a radially inwardly facing surface of the first part. A portion of the first part overlapping the static seal may enclose the static seal around its circumference. Thus, the overlapping portion of the first part may extend axially along only a part of an axial length of the static seal.

A width of the gap in a direction parallel with the rotation axis may be at least 0.1 mm.

An external surface of the static seal may be flush with an external surface of the dynamic seal. Alternatively, or in addition, an external surface of the dynamic seal may be flush with an external surface of the second part. In these ways, external cavities can be avoided and the hygienic design can be improved.

A first static friction coefficient between the static seal and the dynamic seal may be larger than each of a second static friction coefficient and a second dynamic friction coefficient between the dynamic seal and the second surface. In this way, it can efficiently be ensured that the only dynamic sealing interface of the joint will always be between the dynamic seal and the second surface. The first static friction coefficient may for example be at least 20% larger than each of the second static friction coefficient and the second dynamic friction coefficient.

A third static friction coefficient between the static seal and the first part may be larger than each of the second static friction coefficient and the second dynamic friction coefficient between the dynamic seal and the second surface.

The third static friction coefficient may for example be at least 20% larger than each of the second static friction coefficient and the second dynamic friction coefficient.

The first part may comprise an opening. In this case, the static seal may be partly received in the opening. The first part may comprise a single annular opening, e.g. concentric with the rotation axis. Alternatively, the first part may comprise a plurality of openings.

The joint may further comprise a forcing element arranged to force the static seal against the dynamic seal. The forcing element may comprise a spring arranged to push the static seal which in turn causes the static seal to push the dynamic seal against the second surface. When the static seal is pushed by the forcing element, the static seal will be compressed in an axial direction parallel with the rotation axis, and will expand in radial directions with respect to the rotation axis. The radial expansion of the static seal increases the sealing against the first part.

Although the static seal may be elastic to thereby be configured to exert a force on the dynamic seal by being compressed, the elastic properties of the static seal may degrade over time. The forcing element enables the static seal to reliably push against the dynamic seal even if the static seal ages to maintain only a single dynamic sealing interface. Also in this way, the forcing element improves the performance of the joint.

The forcing element may be received in the opening.

The forcing element may comprise a spring, such as one or more compression springs. Examples of compression springs comprise coil springs and wave springs.

The joint may further comprise a static secondary seal configured to seal between the first part and the dynamic seal. The secondary seal may be positioned radially inside the static seal with respect to the rotation axis. The secondary seal serves as a backup static seal.

The secondary seal may be a face seal. Alternatively, or in addition, the secondary seal may be an O-ring. The secondary seal may comprise, or may be constituted by, a rubber material and/or an elastomer. The material of the secondary seal may be a food grade material, for example according to the directives of the U.S. Food and Drug Administration (FDA). The secondary seal may be made of a material having a Shore A hardness of less than 80, such as less than 70, such as less than 60, for example according to DIN 53505 or ISO 868:2003. The secondary seal may be annular and concentric with the rotation axis.

A fourth static friction coefficient between the secondary seal and the dynamic seal may be larger than each of the second static friction coefficient and the second dynamic friction coefficient between the dynamic seal and the second surface. The static friction force from the interface between the secondary seal and the dynamic seal provides an improved resistance against relative movements between the first part and the dynamic seal. The fourth static friction coefficient may for example be at least 20% larger than each of the second static friction coefficient and the second dynamic friction coefficient.

The secondary seal may be compressed between the first part and the dynamic seal. The compression of the secondary seal contributes to pushing to the dynamic seal against the second surface.

The joint may be a robot joint, i.e. a joint of an industrial robot.

According to a second aspect, there is provided an industrial device comprising a joint according to the first aspect. The industrial device may be an industrial robot. The joint according to the first aspect may thus be a joint for an industrial device. The industrial robot may comprise a manipulator having at least two joints.

### BRIEF DESCRIPTION OF THE DRAWINGS

Further details, advantages and aspects of the present disclosure will become apparent from the following description taken in conjunction with the drawings, wherein:

FIG. 1: schematically represents a side view of an industrial robot comprising a plurality of joints;

FIG. 2: schematically represents a cross-sectional side view of one of the joints; and

FIG. 3: schematically represents an enlarged view of section A in FIG. 2.

### DETAILED DESCRIPTION

In the following, a joint comprising a dynamic seal and a static seal, and an industrial robot comprising such joint, will be described. The same or similar reference numerals will be used to denote the same or similar structural features.

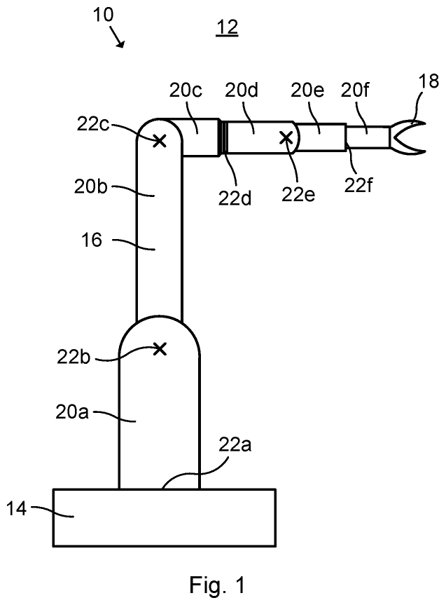

FIG. 1 schematically represents a side view of an industrial device, here exemplified as an industrial robot 10. The industrial robot 10 is exemplified as a six axis industrial robot but the present disclosure is not limited to this type of industrial device. FIG. 1 further shows an external region 12 outside the industrial robot 10.

The industrial robot 10 of this example comprises a base member 14, a manipulator 16 movable relative to the base member 14, and an end effector 18 at a distal end of the manipulator 16. The manipulator 16 of this specific example comprises a first link 20a distal of the base member 14 and rotatable around a vertical axis relative to the base member 14 at a first joint 22a, a second link 20b distal of the first link 20a and rotatable around a horizontal axis relative to the first link 20a at a second joint 22b, a third link 20c distal of the second link 20b and rotatable around a horizontal axis relative to the second link 20b at a third joint 22c, a fourth link 20d distal of the third link 20c and rotatable relative to the third link 20c at a fourth joint 22d, a fifth link 20e distal of the fourth link 20d and rotatable relative to the fourth link 20d at a fifth joint 22e, and a sixth link 20f distal of the fifth link 20e and rotatable relative to the fifth link 20e at a sixth joint 22f. The sixth link 20f comprises an interface (not denoted) to which the end effector 18 is attached. The industrial robot 10 comprises an electric motor and a gearbox (not shown) for driving each joint 22a-22f.

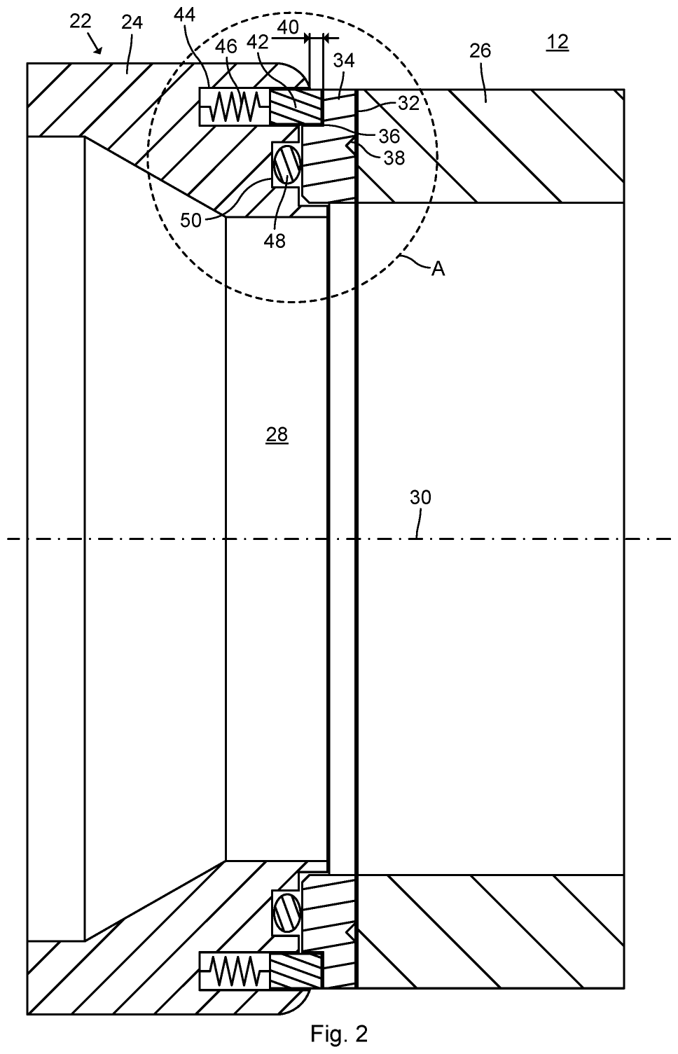

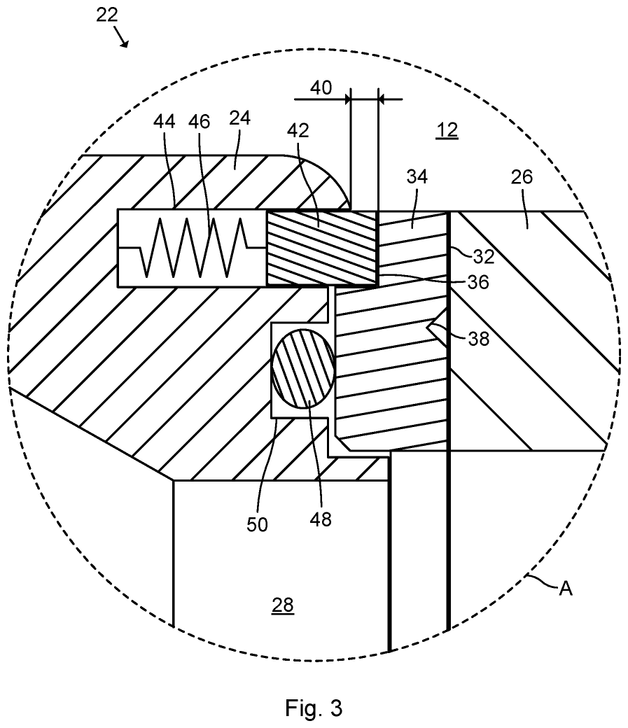

FIG. 2 schematically represents a cross-sectional side view of a joint 22, and FIG. 3 schematically represents an enlarged view of section A in FIG. 2. With collective reference to FIGS. 2 and 3, the joint 22 comprises a first part 24 and a second part 26. In this example, the first part 24 and the second part 26 are made of metal. The first part 24 and the second part 26 are here hollow and enclose an internal region 28 therein.

The second part 26 is rotatable relative to the first part 24 about a rotation axis 30. Unless otherwise indicated, a radial direction and an axial direction refer to a radial direction with respect to the rotation axis 30 and an axial direction parallel with the rotation axis 30, respectively.

In this non-limiting and illustrative example, the joint 22, the first part 24 and the second part 26 correspond to the fourth joint 22d, the third link 20c and the fourth link 20d, respectively, in FIG. 1. The joint 22 may however constitute any of the joints 22a-22f of the industrial robot 10.

The second part 26 comprises a second surface 32. The second surface 32 of this example is annular, concentric with the rotation axis 30 and transverse to the rotation axis 30. The second surface 32 is thus an axial surface.

The joint 22 further comprises a dynamic seal 34. The dynamic seal 34 is configured to dynamically seal against the second surface 32. In this example, the dynamic seal 34 is a face seal made of plastic, such as PTFE. Moreover, the dynamic seal 34 is annular and concentric with the rotation axis 30 in this example. The dynamic seal 34 in FIGS. 2 and 3 comprises an optional step 36. The dynamic seal 34 further comprises an optional incision 38 for collecting grinding particles. In an alternative example, the dynamic seal 34 comprises a plurality of such incisions 38.

FIGS. 2 and 3 each shows a gap 40 between the first part 24 and the dynamic seal 34. As one non-limiting example, a width of the gap 40 may be 2 mm in an axial direction. The gap 40 is here annular and concentric with the rotation axis 30.

The joint 22 further comprises a static seal 42. The static seal 42 is an elastic face seal and is in this example an elastomer, which is softer than for example PTFE. The static seal 42 is here annular and concentric with the rotation axis 30. The first part 24 partly overlaps the static seal 42 radially outside the static seal 42. The portion of the first part 24 partly overlapping the static seal 42 is annular and smoothly curved to provide a convex shape. The static seal 42 seals the gap 40. Due to the gap 40, the static seal 42 is exposed to the external region 12. The static seal 42 is thus visible along the entire gap 40 from the external region 12. There is no bacterial pocket radially outside the static seal 42 in the gap 40.

As shown in FIGS. 2 and 3, an external surface of the static seal 42 is flush with an external surface of the dynamic seal 34. Moreover, the external surface of the dynamic seal 34 is flush with an external surface of the second part 26. In this example, the external surfaces of each of the static seal 42, the dynamic seal 34 and the second part 26 are cylindrical. In these ways, there are no external cavities between the first part 24 and the second part 26. The joint 22 can therefore be cleaned very efficiently, and the sealing solution comprising the dynamic seal 34 and the static seal 42 can fulfill various hygienic requirements within the food and beverage industry.

The first part 24 of this example comprises an opening 44. The opening 44 is here exemplified as an annular groove concentric with the rotation axis 30. An axial dimension of the opening 44 is larger than a radial dimension of the opening 44 in this example.

The joint 22 of this example further comprises a spring 46. The spring 46 is here exemplified as a metal wave spring seated in the opening 44. The spring 46 is one example of a forcing element according to the invention. A part of the static seal 42 is received in the opening 44. A part of the static seal 42 is also seated in the step 36 in the dynamic seal 34 in this example.

The spring 46 is compressed and thereby exerts an axial force on the static seal 42 (to the right in FIGS. 2 and 3). Due to the force on the static seal 42, the static seal 42 is compressed in the axial direction and is expanded in the radial direction against the first part 24. The compression of the static seal 42 causes the static seal 42 to push axially against the dynamic seal 34. As a result, the dynamic seal 34 is pushed against the second surface 32. The spring 46 thus constitutes one example of a forcing element arranged to force the static seal 42 against the dynamic seal 34.

As an alternative, the static seal 42 may be compressed directly against a bottom of the opening 44. Also in this way, the static seal 42 can be arranged to push the dynamic seal 34 against the second surface 32. In this case, the spring 46 can be omitted. However, the spring 46 ensures forcing of the dynamic seal 34 against the second surface 32 even if the static seal 42 degrades over time.

The joint 22 of this example further comprises an elastic and static secondary seal 48. The secondary seal 48 is positioned radially inside the static seal 42 and functions as a backup seal. The secondary seal 48 is here exemplified as an elastomer O-ring. The secondary seal 48 is in this example seated in an annular recess 50 in the first part 24. Each of the secondary seal 48 and the recess 50 is concentric with the rotation axis 30. The secondary seal 48 is compressed between the first part 24 and the dynamic seal 34 and thereby seals between the first part 24 and the dynamic seal 34. Due to this compression, the secondary seal 48 exerts an axial force on the dynamic seal 34 contributing to push the dynamic seal 34 against the second surface 32.

In this example where the static seal 42 is an elastomer, where the dynamic seal 34 is made of plastic and where the second part 26 is made of metal, a first static friction coefficient between the static seal 42 and the dynamic seal 34 is substantially higher than both a second static friction coefficient between the dynamic seal 34 and the second part 26, and any second dynamic friction coefficient between the dynamic seal 34 and the second part 26. Moreover, also a third static friction coefficient between the first part 24 (here made of metal) and the static seal 42 is substantially higher than the second static friction coefficient and the second dynamic friction coefficient.

Furthermore, also a fourth static friction coefficient between the secondary seal 48 (here an elastomer) and the dynamic seal 34 is substantially higher than the second static friction coefficient and the second dynamic friction coefficient. It is thereby ensured that there is always only one dynamic sealing interface in the joint 22, namely between the dynamic seal 34 and the second part 26, and that the interfaces between the first part 24 and the static seal 42 and between the static seal 42 and the dynamic seal 34 remain static during movements of the joint 22. Since the joint 22 can maintain only one dynamic interface during operation, lubrication of the static parts can be avoided, fewer surface treatments are needed and a more accurate prediction of lifetime of the joint 22 can be made.

The provision of the static seal 42 as visible from the external region 12 results in a very hygienic design. Since the dynamic seal 34 is separated from the first part 24 by the static seal 42 and in this example also by the secondary seal 48, there is no contact between the metal first part 24 and the plastic dynamic seal 34. The hygienic design of the joint 22 is therefore improved and a portion of the first part 24 adjacent to the static seal 42 does not have to be surface treated.

Moreover, since the second part 26 is separated from the first part 24 by the static seal 42 and the dynamic seal 34, and in this example also by the secondary seal 48, there is no contact between the metal first part 24 and the metal second part 26. Thus, the joint 22 efficiently avoids metal to metal contact and the plastic dynamic seal 34 is only in contact with one metal part, namely the second part 26. Also this improves the hygienic design of the joint 22. The joint 22 can thus efficiently be used to withstand harsh washdown processes and maintain a hygienic environment over time.

While the present disclosure has been described with reference to exemplary embodiments, it will be appreciated that the present invention is not limited to what has been described above. For example, it will be appreciated that the dimensions of the parts may be varied as needed. Accordingly, it is intended that the present invention may be limited only by the scope of the claims appended hereto.

1. A joint comprising:
a first part and a second part rotatable relative to each other about a rotation axis, the second part having a second surface;
a dynamic seal arranged to dynamically seal against the second surface; and
a static seal arranged to seal a gap between the first part and the dynamic seal, and arranged to push the dynamic seal against the second surface;
wherein the static seal in the gap is exposed to an external region outside the joint.

2. The joint according to claim 1, wherein the second surface is a substantially axial surface with respect to the rotation axis.

3. The joint according to claim 1, wherein the static seal is made of a material that is softer than a material of the dynamic seal.

4. The joint according to claim 1, wherein the first part partly overlaps the static seal.

5. The joint according to claim 1, wherein an external surface of the static seal is flush with an external surface of the dynamic seal.

6. The joint according to a claim 1, wherein an external surface of the dynamic seal is flush with an external surface of the second part.

7. The joint according to claim 1, wherein a first static friction coefficient between the static seal and the dynamic seal is larger than each of a second static friction coefficient and a second dynamic friction coefficient between the dynamic seal and the second surface.

8. The joint according to claim 1, wherein the first part comprises an opening, and wherein the static seal is partly received in the opening.

9. The joint according to claim 1, further comprising a forcing element arranged to force the static seal against the dynamic seal.

10. The joint according to claim 8, wherein the forcing element is received in the opening.

11. The joint according to claim 9, wherein the forcing element comprises a spring.

12. The joint according to claim 1, further comprising a static secondary seal configured to seal between the first part and the dynamic seal, the secondary seal being positioned radially inside the static seal with respect to the rotation axis.

13. The joint according to claim 12, wherein the secondary seal is compressed between the first part and the dynamic seal.

14. The joint according to claim 1, wherein the joint is a robot joint.

15. An industrial device comprising a joint having a first part and a second part rotatable relative to each other about a rotation axis, the second part having a second surface;
a dynamic seal arranged to dynamically seal against the second surface; and
a static seal arranged to seal a gap between the first part and the dynamic seal, and arranged to push the dynamic seal against the second surface;
wherein the static seal in the gap is exposed to an external region outside the joint.

16. The joint according to claim 2, wherein the static seal is made of a material that is softer than a material of the dynamic seal.

17. The joint according to claim 2, wherein the first part partly overlaps the static seal.

18. The joint according to claim 2, wherein an external surface of the static seal is flush with an external surface of the dynamic seal.

19. The joint according to claim 2, wherein an external surface of the dynamic seal is flush with an external surface of the second part.

20. The joint according to claim 2, wherein a first static friction coefficient between the static seal and the dynamic seal is larger than each of a second static friction coefficient and a second dynamic friction coefficient between the dynamic seal and the second surface.
